(19) United States
(12) Patent Application Publication
(10) Pub. No.: US 2021/0280103 A1
(43) Pub. Date: Sep. 9, 2021

(54) PUBLICITY AFFIXING DEVICE

(71) Applicant: Valerio Venturi, Misano Adriatico (IT)

(72) Inventor: Valerio Venturi, Misano Adriatico (IT)

(21) Appl. No.: 17/257,908

(22) PCT Filed: Jul. 5, 2019
(86) PCT No.: PCT/IB2019/055743

§ 371 Date: Jan. 5, 2021

(30) Foreign Application Priority Data
Jul. 6, 2018 (IT) 102018000007000

(51) Int. Cl. G09F 17/00

(52) U.S. Cl. CPC G09F 17/00; G09F 2017/005; G09F 2017/0025

(57) ABSTRACT

A publicity device may be used to affix a banner to a pre-existing road sign fixed to the ground, developing in a vertical direction and thus extraneous to the device. The device includes at least one first and at least one second structural unit, coupleable to a locking fixed directly to the pole, and uncoupleable therefrom, independently of each other, where at least one is coupleable to a locking fixed to the pole in one point, varying according to the dimension of the banner. Each of the structural units may include a coupling to the banner, which are active both in a coupled condition, where the banner is in traction, and in an uncoupled condition of the structural units where traction of the banner therebetween is absent.

### FIELD OF THE INVENTION

The present invention relates to a publicity affixing device, and it has been studied with particular reference to the affixing of banners. The device is particularly adapted for affixing to pre-existing supports and are, thus the supports are not considered as forming part of the device, however, other solutions are not excluded. Examples of such supports include poles, such as vertical road signs or lampposts, the walls of buildings, fencing.

### BACKGROUND

Publicity banners are made of foldable material, such as, for example, fabric, sheets of composite material, etc. and they have two main faces, on one or both of which a publicity message is printed. The present invention is able to use currently existing standard posters and does not exclude the use of posters of other similar materials or of other dimensions.

In the sector, said posters are commonly called “banners”.

The main object of the banner is to remain in an unfolded configuration so as to allow an optimum view of the publicity message, under penalty of the ineffectiveness thereof.

In order to achieve this result, it is necessary to face a series of problems, such as the action of the wind, the tensioning of the various-sized banners with one same device, the interchangeability of the banner.

For this purpose, support devices have been developed over the years, which put the banners under traction in a vertical direction and contrasting the action of the wind, causing the banner to rotate or fold about a vertical axis.

One first known example of a publicity affixing device is described in patent application EP2226781. This structure has a main vertical support rod, said upright, designed to be coupled, for example, to a road sign or to a lamppost, and a pair of horizontal rods, said beams. The banner has two eyelets at the ends, in a vertical direction, into which the beams are inserted. The beams are tilting with respect to the upright under the action of the wind, and they are brought back into the starting position by leaf springs, which hinder push on the beams, hindering the tilting movement thereof.

Opposition to the wind by this device is optimum and it is easy and cheap to make, furthermore, the insertion of banners is highly practical and quick.

However, this device has practical limitations as regards the adaptability to banners of varying dimensions.

In fact, EP2226781 describes a device capable of going up and down telescopically with respect to an affixing position, however, it cannot be adapted to banners of varying dimensions.

One second known example of a publicity affixing device is described in patent application EP3291211. It comprises deformable beams. Such solution, however, appears highly onerous and complicated to construct, because the beams are formed by pieces of rod hinged to one another with the interposition of springs. Furthermore, with every movement, they deform the banner, with the risk of ruining it.

This device can be adapted to banners of varying dimensions, but within the limit of the dimensions of the upright, and with a highly complicated, costly and delicate mechanism. In fact, the mechanism, which allows the adaptability comprises an annular cable arranged to rotate between two pulleys placed at the ends of the beam. A tensioning spring is locked to the cable by means of clamps and serves to pull a hook with it, with respect to the upright, during the rotation of the cable, for coupling to the upper beam, while a second hook for coupling to the lower beam remains fixed. When the two beams are coupled to the hooks and have been spaced apart by a section corresponding to the height of the banner, the spring comes under tension against the upper hook and it is not possible to rotate the cable further. The mechanism is locked, constraining one of the pulleys to the upright by means of a pin.

As will be noted, the locking is quite difficult, because, with every affixing, the pin must cross at least three holes, the one for the pulley, the one for the upright and the one for the fork supporting the pulley on the upright. This is made more difficult by the fact that one hand must hold the cable under tension and considerable force must also be exerted to prevent the beams from unhooking. However, the accidental unhooking of the banner is always possible when it gathers wind from behind, because the force of the wind on the banner tends to bring the beams towards one another against the thrust of the spring, detaching them from the hooks. Furthermore, the attaching of the spring to the cable with screws can be uncertain, or otherwise, it can damage the cable and result in breaking.

Other documents known in patent literature include the following.

U.S. Pat. Nos. 3,824,724 and 3,831,304 describe two supports between which a banner can be hung, attached to a pole by means of screws. The reciprocal position thereof is unique and therefore they are not able to receive banners of varying dimensions.

EP2395498 describes a guide pole integrated with the support beams of the banner and with a mechanism for the lifting thereof. It is a highly costly device as it requires an imposing pole and cannot be installed everywhere, nor, more importantly, on a pre-existing pole. It is only adapted to permanent installations. The beams move up and down at a fixed distance from each other locked by the engagement thereof on the belt of a pulley.

DE202004021335 describes a sliding guide with a ratchet for adjusting the tension of the banner, however, it cannot be applied to any banner size, but it serves only to mount, first the support structure in a forced position on the pole and then to move adjustment members for tensioning the bar.

### SUMMARY OF THE EMBODIMENTS

It is an object of the present invention to overcome all, or some, of the drawbacks of the prior art.

It is a preferred object of the invention to provide a publicity affixing device, which is cheap and easy to make.

It is a further preferred object to provide a publicity affixing device, which is reliable and easy to use.

It is a further preferred object to provide a publicity affixing device, which can easily be adapted to varying dimensions of banners.

It is a further preferred object to provide a publicity device, which maintains the function of reaction to the wind.

According to a first general aspect thereof the present invention relates to a publicity device for affixing a banner to a pre-existing road sign (10) planted in the ground, developing in a vertical direction and thus extraneous to the device, comprising at least one first and at least one second structural unit (15, 20), which can be coupled, with a fixed locking, directly to the pole (10), and uncoupled therefrom, independently of each other, where at least one can be coupled to a fixed locking to the pole in a varying point (2a, 2b) according to the size (vertical) of the banner (26), each structural unit being provided with:
means for coupling (25a, 25b) to the banner (5), which are active both in said coupled condition, wherein the banner is in traction, and in said uncoupled condition of the structural units (15, 20) where traction of the banner is absent therebetween.

Advantageously, it is possible to attach the banner first to the device and then to attach the device to the pole, placing the units at a distance, which depends on the size of the banner.

According to some preferred embodiments of the invention, the banner (5) comprises at least one pair of eyelets (27) parallel and spaced apart from each other, and the coupling means of each structural unit comprise at least one rod (26), transverse to said vertical direction, which can be inserted into one of said eyelets, and coupleable and uncoupleable from the remaining part (30a, 30b) of the structural unit, where the rod (26) can be coupled stably to said remaining part (30a, 30b) in the absence of traction of the banner.

In this case, preferably, the rod is coupled to the remaining part of the structural unit by means of a removable tilting pin.

According to some preferred embodiments of the invention, at least one structural unit, preferably both, comprises pole tightening means, for example, a pair of jaws (50, 51) or a band.

Advantageously, such structural unit, or both, is freely lockable in any position of the pole, without needing to arrange the pole with hooking interfaces, such as, for example, holes for screws).

According to a preferable general feature of the invention, at least one of the two units comprises traction means (60) (for example, elastic) for the banner in said vertical direction.

Advantageously, they come into traction to allow the structural units to be coupled to the pole, at a mutual distance greater than the distance permitted by only the extension of the banner in a vertical direction.

In this case, preferably, at least one of the two structural units comprises at least one rod (26), transverse to said vertical direction, which can be coupled to the banner (5), and pole tightening means (50, 51), where the elastic traction means (60) are operatively interposed between the transverse rod (26) and the pole tightening means (50, 51).

According to some preferred embodiments, said traction means comprise at least one upright element with a longitudinal development in the direction of traction, a telescopic element slides relatively to the upright element in the direction of longitudinal development, hindered by elastic means operatively interposed between the upright element and the telescopic element, the telescopic element slides with respect to the upright element in an integral manner to pulling means of the banner in the direction of traction.

In this case, for example, the elastic means comprise an elastic element housed inside the telescopic element, where the latter is provided with a groove inside which a pin slides, coupled to the upright element, and where the elastic element insists on such pin, exerting a thrust between it and the telescopic element.

Advantageously, this reduces the dimensions without loss of functionality.

According to some preferred embodiments of the invention, at least one of the two structural units comprises at least one rod (26), transverse to said vertical direction, coupleable to the banner (5), where said transverse rod is tilting about a vertical axis (40), and at least one of the structural units (15, 20) comprises elastic means for contrasting such tilting.

Advantageously, this overcomes the prejudice set by EP3291211 that a publicity affixing device adaptable to varying dimensions of banners, which maintains the function of interaction with the wind, must be complicated, costly and delicate. EP3291211 indeed sets this prejudice because it follows EP2226781 in the sector.

According to some preferred embodiments of the invention, at least one of the two structural units comprises at least one rod, transverse to said vertical direction, coupleable to the banner, where said transverse rod is elastically deformable, where preferably, the elasticity brings it back to a substantially rectilinear configuration.

According to a second general feature thereof, the present invention relates to a method for affixing publicity banners to a pre-existing road sign planted in the ground, developing in a vertical direction, characterised by the following steps:
arranging at least one pair of structural units in a condition, in which at least one is uncoupled from the pole;
in said uncoupled condition, joining the banner stably to the two structural units in a loose condition;
distancing the structural units from each other to a distance of traction of the banner,
locking the structural units fixed to the pole at said distance of traction between each other.

The same steps can be repeated with respective banners having different vertical dimensions from one another.

According to a third general aspect thereof, the invention relates to a method for affixing publicity banners, characterised by the following steps:
arranging at least one pair of structural units different from each other and each provided with means thereof for locking to a support;
coupling a banner to each structural unit,
locking one of the two structural units to a support;
distancing the structural units from each other until past activation of the traction device,
locking the other structural unit to the support in a position of traction of the banner.

In this case, the step of locking the banner against the uncoupling from the structural units before traction is preferably comprised. Advantageously, in this way, both hands are free for attaching the units to the pole or wall, avoiding the risk of uncoupling in the event of strong wind.

Replacing a banner with a one of a different size is also particularly practical. In fact, such operation comprises the steps of releasing only one of the two structural units from the pole or wall, uncoupling the first banner from both structural units, coupling the second banner to both structural units, and locking the structural unit to the pole or wall again in a position depending on the dimensions of the new banner.

According to a fourth aspect thereof, the invention relates to a method for affixing publicity banners, characterised by the following steps:
arranging a banner and a plurality of pairs of structural units, the units of each pair being movable between one another, at least in a pulling direction of the banner and lockable to prevent such movement, coupling the units of each pair opposite each other to the banner so as to mutually define a pulling direction of the banner, at least two pulling directions being mutually inclined.

### BRIEF DESCRIPTION OF THE DRAWINGS

Further characteristics and advantages of the present invention will become clearer from the following detailed description of preferred embodiments thereof, with reference to the appended drawings and provided by way of an indicative and non-limiting example. In such drawings:

FIG. 1 schematically shows a device according to the present invention coupled to banners of varying dimensions;

FIG. 2 schematically shows a side view of a device in FIG. 1 coupled to a pole;

FIG. 3 schematically shows a perspective view of a device in FIG. 1 where parts have been removed for descriptive necessity;

FIG. 4 schematically shows a view similar to the one in FIG. 3, partially in section;

FIG. 5 schematically shows a sectional view according to the plane V in FIG. 7;

FIG. 6 and FIG. 7 schematically show a view from above and a front view of the device in the previous figures;

FIGS. 8, 9 and 10 show a variation with a windproof leaf spring, in particular, FIG. 9 represents a detail on an enlarged scale in FIG. 8 and FIG. 10 represents a view from above of the device in FIG. 8.

### DETAILED DESCRIPTION OF THE EMBODIMENTS

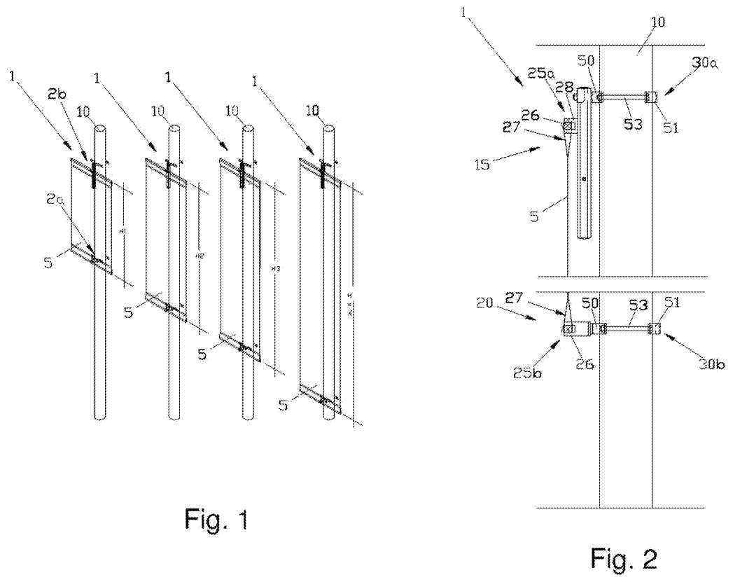

Below, reference is made to the embodiment represented in FIGS. from 1 to 7. FIG. 1 shows a series of publicity devices for affixing banners, where each of these is globally indicated with numeral reference 1.

The devices 1 in the series are all equal and coupled to respective banners 5 having different dimensions, in particular a different height H1, H2, H3.

Each of the devices 1 is coupled to a support 10, which is separate from the device. A support is referred to below, for simplicity, given by a pole 10, which has a vertical longitudinal development coinciding with the direction of traction of the banner 5, meaning that other supports are possible, such as, for example, walls, fences, etc. Such pole is, for example, a road sign, such as a lamppost or a pole of a road sign, and represents the commonest pre-existing support in the place of affixing.

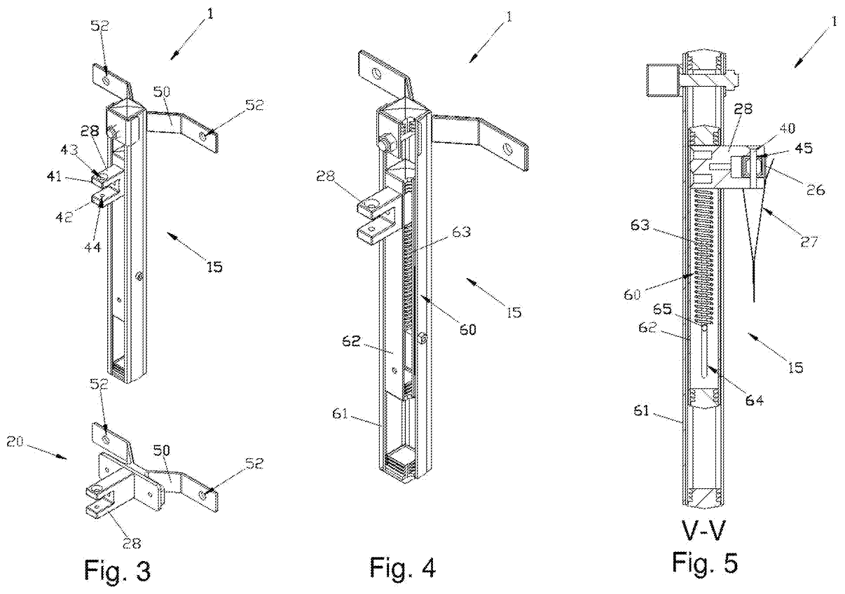

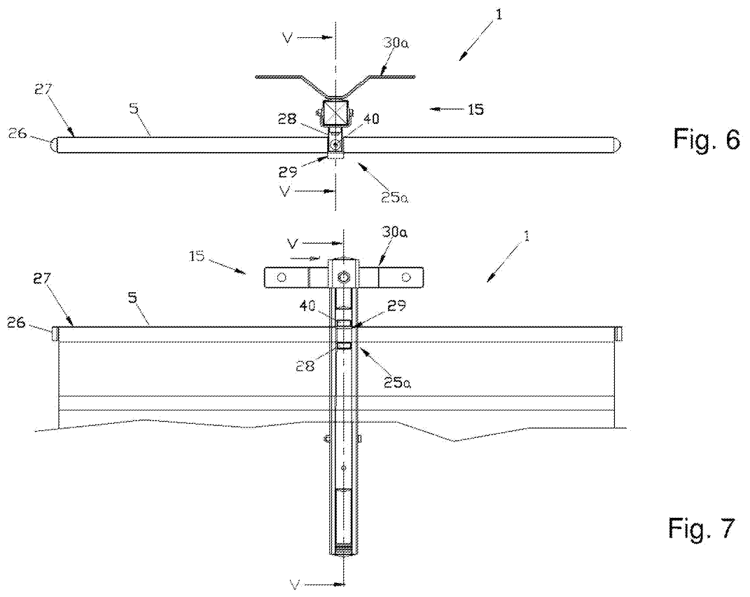

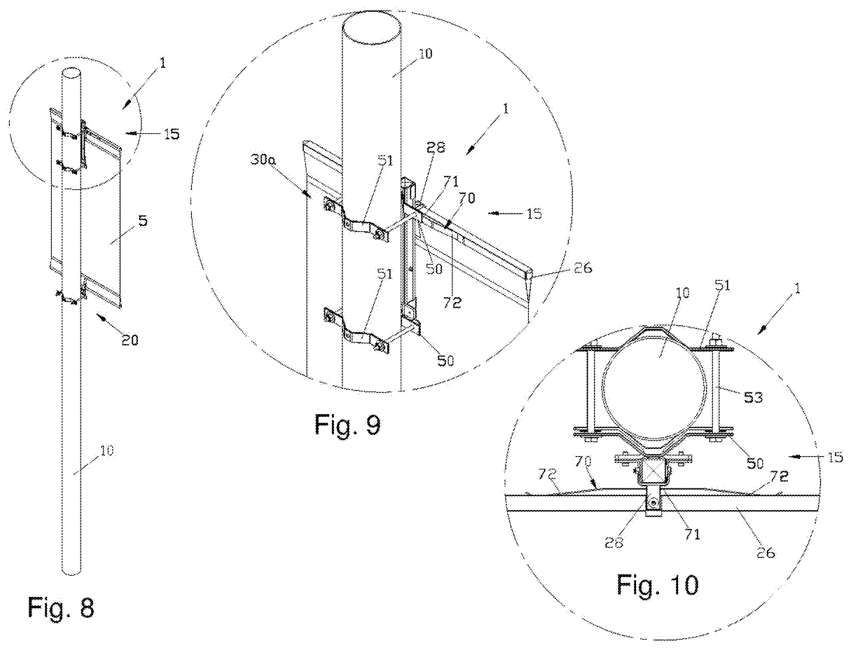

As can be seen better in FIGS. 2 and 3, each device 1 comprises a pair of structural units 15 and 20 designed for coupling both to the banner 5 and to the pole 10.

The structural units 15 and 20 are disjointed from each other and freely movable with respect to each other. They are locked, one to the other, only through the locking thereof to the pole 10.

Each of these comprises respective means for coupling 25a and 25b to the banner 5 and means for attaching 30a and 30b to the pole 10.

The coupling means 25a and 25b each have a rod 26 designed to be inserted in respective eyelets 27 of the banner and said below beams, because, in an affixing condition, they are orthogonal to the vertical pole 10.

The coupling means each have a fork element 28 inside which the central portion of the beam 26 is received.

The eyelet 27 of the banner 5 has a central opening 29 for the passage of the fork 28.

The beam 26 is locked in the fork in a tilting position about a vertical axis by means of a pin 40.

For this purpose, the fork 28 has two arms 41 and 42 parallel to each other and facing in a vertical direction, at least one being provided with a through hole 43 and 44 aligned with a through hole 45 of the central portion of the beam 26. The beam 26 is held in the fork 28 by means of the tilting pin 40 passing through said holes, it is, for example, a screw, a bolt or a pin. In this way, the beam 26, and consequently the banner, can be coupled stably to the affixing means 30a, 30b independently of the action of traction of the banner, thus, even before the two structural units are mutually locked, fixing them to the pole. Furthermore, the beam 26 and the banner are separable from the affixing means to replace the banner.

Each affixing means 30a, 30b comprises at least one pair of flanges 50, 51, with the function of jaws, which can be coupled and uncoupled for tightening the pole 10 between them.

For this purpose, the flanges each have a pair of holes 52 aligned with the corresponding holes of the other flange, inside which respective tightening screws 53 are inserted. Preferably, the flanges are shaped so as to form a convex seat for receiving the pole 10.

When the flange 51 is removed, the flange 50 remains anchored to the relative structural unit and can be attached to a flat surface, such as, for example, a wall, inserting special screws into the holes 52.

One preferred alternative solution is represented by a band, capable of being tightened about the pole.

Thus, it is possible to lock the structural units to the pole at a distance from each other, which can be modified depending on the dimension of the banner. Thus, the pole tightening points 2a and 2b are random and vary according to the dimensions of the banner.

At least one of the structural units 15, 20 is provided with traction means 60 for the banner. In the illustrated example, the traction means 60 are on the unit 15.

They comprise a device capable of elastically opposing the mutual distancing of the units 15 and 20 when they are connected to the banner. In detail, the illustrated traction means 60 comprise a first element with vertical longitudinal development, thus parallel to the pole 10, coinciding with the direction of traction of the banner, said below first upright 61.

The first upright 61 is fixed with respect to the respective affixing means 30a.

The traction means 60 comprise a second upright 62 sliding in a telescopic manner with respect to the first upright 61 in a vertical direction.

The fork 28 slides with respect to the first upright 61 in an integral manner to the second upright 62.

An elastic element 63 is operatively interposed between the first and the second upright, for example, a helicoidal spring, so as to recall the second upright upwards when the unit 15 is mounted higher than 20 and they mutually tension a banner in a vertical direction. If the traction means 60 had been present on the lower unit 20, or also thereupon, they would have been oriented so as to recall the movable upright 62 downwards, i.e. away from the upper unit 15.

This recall mechanism allows the banner to be kept with a correct tension between the units 15 and 20 when they are in a condition fixed to the pole, thus, mutually locked.

To minimize volume and maintain functionality, preferably, the elastic element 63 is generally housed in the second upright 62. The latter is provided with a groove 64, inside which a pin 65 slides, coupled to the first upright 61. The elastic element 63 insists on such pin, exerting the thrust between it and the second upright. Preferably, the elastic element 63 is a helicoidal spring with a direction of compression coinciding with the direction of sliding.

With reference to FIGS. from 8 to 10, a variation is shown where the same elements described previously are indicated with the same reference numerals.

The device 1 in FIGS. from 8 to 10 differs from the previous one in that it comprises, in each structural unit 15 and 20, an elastic element 70 operatively interposed between the beam 26 and the affixing means, so as to oppose the tilting of the beam due to the effect of the wind and so as to bring it back into a base position after the movement thereof.

Said elastic element 70, is, for example, a leaf-shaped spring with a convex shape, so as to have a central part 71 corresponding to the bottom of the convexity and two side arms 72 corresponding to the free ends.

The centre 71 of the leaf is coupled in a fixed manner to the fork 28 behind the beam (i.e. it is placed between the beam 26 and the fork 28), for example, by means of one or more screws (not shown), and the two side arms 72 insist on the back of the beam.

As can be noted, it is illustrated by way of example that the affixing means 30a or 30b can have more than one pair of flanges 50, 51. Shown in FIG. 10 and successive are the affixing means 30a with two pairs of flanges locked to the first upright 61 and spaced apart along the longitudinal direction of development thereof.

In use, in an initial released position, at least one of the two structural units 15, 20, preferably the lower one 20, is free, i.e. it is not fixed to the pole 10 or to another support and it is freely movable with respect to the other unit, which has already preferably been fixed, instead, and thus locked, to the support 10.

In such condition, each beam 26 is uncoupled from the fork 28 by removing the pin 40, and in such free condition it is inserted into the respective eyelet 27 of the banner 5. The eyelets of the banner are preferably made at the ends thereof and in any case, parallel and spaced apart from each other.

Thus, the beams 26 are coupled again to the forks reinserting the pins 40 in the holes 43, 44 and 45 due to the passage in the banner offered by the central openings 29. Thus, in such condition, it is not possible to unhook the banner from the units 15 and 20, even though the relative movement thereof in the direction of traction is not locked.

The two structural units 15 and 20 are distanced from each other to put the banner in traction, until triggering the reaction of the elastic element 63.

In such traction condition, the two units 15 and 20 are mutually locked by fixing to the support, for example, to the pole 10. If, in the starting condition, one of the two units had already been fixed, it will suffice to only attach the second.

Although a vertical pulling direction of the banner between the structural units has been described herein, it cannot be excluded that it is oriented in any other direction. This can easily be achieved, for example, with a wall fixing.

Clearly, it is possible to use one or more of other pairs of structural units to create, between them, other pulling directions of the banner intersected with the pulling direction defined for the first pair. For example, two pulling directions can be defined, both inclined with respect to the vertical direction. This allows the banners to be arranged with various orientations, increasing the attraction thereof.

In this case, it is possible to provide the banners with eyelets on several sides, or comprise means for attaching the structural units to the edges of the banners of any other nature, such as, for example, with jaws, or by fusion or gluing to an interchangeable rod of the structural units.

### GENERAL INTERPRETATION OF THE TERMS

In understanding the object of the present invention, the term “comprising” and its derivatives, as used herein, are intended as open-ended terms that specify the presence of declared characteristics, elements, components, groups, integers and/or steps, but do not exclude the presence of other undeclared characteristics, elements, components, groups, integers and/or steps. The above also applies to words, which have similar meanings, such as the terms “comprised”, “have” and their derivatives. Furthermore, the terms “part”, “section”, “portion”, “member” or “element” when used in the singular can have the double meaning of a single part or a plurality of parts. As used herein to describe the above executive form, the following directional terms “forward”, “backward”, “above”, “under”, “vertical”, “horizontal”, “below” and “transverse”, as well as any other similar directional term, refers to a banner affixed so as to have a direction of vertical traction with respect to the ground. Consequently, these terms, used to describe the publicity device, should be interpreted in relation to a publicity device, which supports a banner in such position. Finally, terms of degree, such as “substantially”, “about” and “approximately”, as used herein, are intended as a reasonable amount of deviation of the modified term such that the final result is not significantly changed.

While only selected embodiments have been chosen to illustrate the present invention, it will be apparent from this description to those skilled in the art that various modifications and variations can be made without departing from the scope of the invention as defined in the appended claims. For example, the size, shape, position or orientation of the various components can be modified as needed and/or desired. The components shown directly connected or in contact with each other can have intermediate structures arranged between them. The functions of one element can be performed by two and vice versa. The structures and functions of one embodiment can be adopted in another embodiment. All the advantages of a particular embodiment do not necessarily have to be present at the same time. Any characteristic that is original compared to the prior art, alone or in combination with other characteristics, should also be considered a separate description of further inventions by the applicant, including the structural and/or functional concepts embodied by such characteristics. Therefore, the foregoing descriptions of the embodiments according to the present invention are provided for illustrative purposes only and not for the purpose of limiting the invention as defined by the appended claims and the equivalents thereof.

1. A publicity device for affixing a banner to a pre-existing road sign fixed to the ground, developing in a vertical direction and extraneous to the device, comprising:
at least one first and at least one second structural unit, wherein the structural units are independently coupleable to a locking fixed directly to a pole and independently uncoupleable therefrom, where at least one of the first and second structural units is coupleable to a locking fixed to the pole in one point varying according to the dimension of the banner, each structural unit being provided with:
a means for coupling to the banner, which are active both in a coupled condition when the banner is in traction, and in an uncoupled condition when traction of the banner is absent.

2. A device according to claim 1, wherein the banner comprises at least one pair of eyelets, parallel and spaced apart from each other, and the means for coupling comprise at least one rod, transverse to said vertical direction, which can be inserted into one of said eyelets, coupleable and uncoupleable from a remaining part of the structural unit, wherein the rod can be coupled stably to said remaining part in the uncoupled condition.

3. A device according to claim 2, wherein the rod is coupled to the remaining part of the structural unit by means of a removable tilting pin.

4. A device according to claim 1, wherein at least one structural unit comprises a pole tightening means comprising a pair of jaws

5. A device according to claim 1, wherein at least one structural unit comprises a pole tightening means comprising a band.

6. A device according to claim 1, wherein at least one of the two structural units comprises traction means for the banner in said vertical direction.

7. A device according to claim 6, wherein at least one of the two structural units comprises at least one transverse rod transverse to said vertical direction, which can be coupled to the banner, and pole tightening means, wherein elastic traction means are operatively interposed between the transverse rod and the pole tightening means.

8. A publicity device according to claim 1, wherein at least one of the two structural units comprises at least one rod, transverse to said vertical direction, coupleable to the banner, where said transverse rod tilts about a vertical axis, and at least one of the structural units comprises elastic means for contrasting such tilting.

9. A publicity device according to claim 1, wherein at least one of the two structural units comprises at least one transverse rod transverse to said vertical direction and coupleable to the banner, wherein said transverse rod is elastically deformable, wherein elasticity in the transverse rod brings the transverse rod back to a substantially rectilinear configuration.

10. A method for affixing publicity banners to a pre-existing road sign planted in the ground, developing in a vertical direction, comprising:
arranging at least one pair of structural units in a condition in which at least one is uncoupled from a pole to which the sign is mounted;
in said uncoupled condition, joining the banner stably to the two structural units in a loose condition;
distancing the structural units from each other to a distance that gives traction of the banner,
locking the structural units fixed to the pole at said distance of traction between each other.

11. A method according to claim 10, characterised wherein the method repeats the preceding steps with a second banner having a different vertical dimension from the banner.
